(19) United States
(12) Patent Application Publication
(10) Pub. No.: US 2006/0177194 A1
(43) Pub. Date: Aug. 10, 2006

(54) Digital photo album producing apparatus

(75) Inventors: Chao King, Fremont, CA (US); John R. Christ, Santa Clara, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA TECHNOLOGY U.S.A., INC.

(21) Appl. No.: 11/050,716

(22) Filed: Feb. 7, 2005

(51) Int. Cl. H04N 5/91

(52) U.S. Cl. 386/46

(57) ABSTRACT

The present application relates to a digital photo album producing apparatus which can produce the digital photo album file so that when the digital photo album is reproduced, both of the background music and audio of movie can be reproduced at good balance.

### FIELD

The present invention relates to a digital photo album producing apparatus.

### INTRODUCTION

A removable digital information recording medium such as a compact disk (CD) or a digital versatile disk (DVD) can record both of image data and music data. By utilizing such characteristic of the removable digital information recording medium, a digital photo album can be developed. For instance, several still image data and background music data can be recorded onto a CD-R. When the recorded CD-R is reproduced by a CD player, several still images can be reproduced sequentially with background music like a slide show.

In addition to the still images, because a recent development of digital camera makes digital camera possible to take both of still images and movie by one digital camera, user desires to include movie also into the digital photo album.

However, such digital photo album exhibits certain drawback. If both of audio of movie and background music are reproduced simultaneously, only one of the audio and the background music might be heard. The user is frustrated by such situation.

Therefore, it is desirable to produce a digital photo album without complicated data processing so that when both of the audio of the movie and the background music are reproduced simultaneously, both of the audio and the background music can be heard at good balance.

### SUMMARY

According to various embodiments, the present teachings can provide a digital photo album producing apparatus. The digital photo album producing apparatus can comprise a reading section which can read image data including at least one of still image data and movie data from an image data recording medium. The digital photo album producing apparatus can comprise an image data storing section which can store image data read by the reading section. The digital photo album producing apparatus can comprise a data storing section which can store at least one background music data. The digital photo album producing apparatus can comprise a selecting section by which an user can select background music based on the background music data stored in the data storing section. The digital photo album producing apparatus can comprise a processing section which can produce a digital photo album file based on the image data stored in the image data storing section and the background music data selected by the selecting section. The digital photo album producing apparatus can comprise a recoding section which can record the digital photo album file produced by the processing section onto a removable digital information recording medium. The processing section can produce the digital photo album file so that the background music data can be reproduced during reproducing of the image data, and the audio data of the movie data can be reproduced during reproducing of the movie data. Further, the processing section can produce the digital photo album file so that when the background music data and the audio data are reproduced simultaneously, the background music data can be reproduced by using only one of two stereo channels and the audio data can be reproduced by using only the other of the two stereo channels, and when the background music data is reproduced without reproducing of the audio data, the background music data can be reproduced by using both of the two stereo channels.

### BRIEF DESCRIPTION OF THE DRAWINGS

FIG. 1 illustrates a figure for explanation of image data, according to certain embodiments.

FIG. 2 illustrates a figure for explanation of image data, according to certain embodiments.

FIG. 3 illustrates a figure for explanation of image data, according to certain embodiments.

FIG. 4 illustrates a figure for explanation of calculation of reproducing time of a digital photo album file, according to certain embodiments.

FIG. 5 illustrates a figure for explanation of a digital photo album file, according to certain embodiments.

FIG. 6 illustrates a perspective view of a digital photo producing apparatus, according to certain embodiments.

FIG. 7 illustrates a block diagram of a digital photo producing apparatus, according to certain embodiments.

FIG. 8 illustrates a graphic display of a digital photo producing apparatus, according to certain embodiments.

FIG. 9 illustrates a graphic display of a digital photo producing apparatus, according to certain embodiments.

FIG. 10 illustrates a graphic display of a digital photo producing apparatus, according to certain embodiments.

### DESCRIPTION OF CERTAIN EMBODIMENTS

Apparatus

In certain embodiments, a digital photo album producing apparatus can comprise at least one of a reading section, an image data storing section, a data storing section, a selecting section, a calculating section, a processing section and a recoding section.

In certain embodiments, a digital photo album producing apparatus can comprise a personal computer.

In certain embodiments, the reading section can read and obtain image data from an image data recording medium.

In certain embodiments, the image data recording medium can store the image data taken by a digital still camera, a digital video camera and so on. Examples of the image data recording medium consistent with certain embodiments of the invention include, but are not limited to, a digital memory card, a compact disk (CD) (e.g., CD-R, CD-RW, etc), and a digital versatile disk (DVD) (e.g., DVD-R, DVD-RW, DVD+RW, etc.). Various types of digital memory cards compatible with certain embodiments of the invention include, but are not limited to, secure digital (SD) memory card, Compact Flash™, Smart Media™, Memory Stick™, and the like.

In certain embodiments, the image data can comprise still image data and/or movie data. In certain embodiments, the image data can comprise only still image data. In certain embodiments, the movie data can comprise audio data including voice of people and/or sound of surrounding. In certain embodiments, the movie data can comprise data of the reproducing time of the movie data. In certain embodiments, each of the still image data and the movie data can be stored in different files respectively in the image data recording medium. In certain embodiments, the format of the still image data stored in the image data recording medium can be JPEG format, and so on. In certain embodiments, the format of the movie data including the audio data stored in the image data recording medium can be AVI format, MOV format and so on. In certain embodiments, the image data stored in the image data recording medium can be included in a standard image related file. Example of the standard image related file consistent with embodiments of the invention include, but are not limited to, a file under DCIM directory, AVI file, MOV file and JPG file.

In certain embodiments, the reading section might not read all data included in the image data recording medium. In certain embodiments, the reading section can read only the standard image related file from the various files or data recorded in the image data recording medium. Examples of the reading section consistent with certain embodiments of the invention include, but are not limited to, a CD reader, a CD reader/writer, a DVD reader, a DVD reader/writer, a digital memory card reader and a digital memory card reader/writer. In certain embodiments, the reading section can be means for reading the image data (in other word, reading means).

In certain embodiments, the image data storing section can store image data read and obtained by the reading section. In certain embodiments, the image data storing section can store the image data temporarily and can delete the image data when the producing of a digital photo album file based on the image data stored in the image data storing section is completed. In certain embodiments, the image data storing section can store the image data whose format (e.g., JPEG, AVI, MOV, and so on) is same with the original image data stored in the image data recording medium. Examples of the image data storing section consistent with certain embodiments of the invention include, but are not limited to, a memory such as a non volatile memory (e.g., a non volatile random access memory (NVRAM), M RAM, P RAM, Fe RAM, Flash RAM and the like) and a hard disk.

In certain embodiments, the data storing section can store at least one of background music data. In certain embodiments, the format of the background music data stored in the data storing section can be WAVE format and so on. In certain embodiments, the background music data can comprise reference information of each of the background music (e.g., a title, a reference number, an artist and so on), reproducing time of each of the background music data and so on in addition to the background music itself. In certain embodiments, each background music data can be stored in the data storing section in the form of a background music file. In certain embodiments, the data storing section can store minimum time data and maximum time data for reproducing time of each still image. In certain embodiments, the data storing section can store the authorized data for the verification of the removable digital information recording medium. In certain embodiments, the data storing section can store format data for calculation. Examples of the data storing section consistent with certain embodiments of the invention include, but are not limited to, a memory such as a non volatile memory (e.g., a non volatile random access memory (NVRAM), M RAM, P RAM, Fe RAM, Flash RAM and the like) and a hard disk. In certain embodiments, the image data storing section and the data storing section can be one same component. In certain embodiments, the image data storing section and the data storing section can be different components. In certain embodiments, the image data storing section and/or the data storing section can be means for storing the image data, the background music data and/or other various data (in other words, storing means).

In certain embodiments, an user can select background music based on the background music data stored in the data storing section by utilizing the selecting section. In certain embodiments, the user can select no background music by utilizing selecting section. In certain embodiments, the user can select the still image data and/or the movie data which the user wants to include in the digital photo album file by utilizing the selecting section. Examples of the selecting section consistent with certain embodiments of the invention include, but are not limited to, a keyboard, a mouse, a push button and a touch screen.

In certain embodiments, the recording section can record the digital photo album file produced by the processing section onto a removable digital information recording medium. In certain embodiments, the recording section can record the digital photo album file produced by the processing section onto the removable digital information recording medium according to video image related format (e.g., video CD format, DVD format etc.). In certain embodiments, the recording section can record the original image data (in other words, raw data) originally stored in the image data recording medium into the removable digital information recording medium in addition to the digital photo album file produced by the processing section.

Examples of the removable digital information recording medium consistent with certain embodiments of the invention include, but are not limited to, a digital memory card, a CD (e.g., CD-R, CD-RW etc.), and a DVD (e.g., DVD-R, DVD-RW, DVD+RW, etc.). Various types of digital memory cards compatible with certain embodiments of the invention include, but are not limited to, SD memory card, Compact Flash™, Smart Media™, Memory Stick™, and the like.

Examples of the recording section consistent with certain embodiments of the invention include, but are not limited to, a CD writer, a CD reader/writer, a DVD writer, a DVD reader/writer, a digital memory card writer and a digital memory card reader/writer. In certain embodiments, the recording section can be means for recording the digital image album file onto the removable digital information recording medium (in other words, recording means).

In certain embodiments, the digital photo album producing apparatus can comprise a data input section. In certain embodiments, the user can input operation, number, letter, data or instruction to the digital photo album producing apparatus from the data input section. In certain embodiments, the user can designate orientation of the image data, order of reproducing of the image data or the resolution of the image data. In certain embodiments, the user can input a reference information (e.g., a title, a place of taking photo, a name of person and the like) of the digital photo album file by the data input section. Examples of the data input section consistent with certain embodiments of the invention include, but not limited to, a keyboard, a mouse, a push button and a touch screen. In certain embodiments, the data input section and the selecting section can be one same component. In certain embodiments, the data input section and the selecting section can be different components. In certain embodiments, the selecting section and/or the data input section can be means for inputting background music selection and/or various instruction, data (in other words, inputting means).

In certain embodiments, the digital photo album producing apparatus can comprise a sound output section. In certain embodiments, the sound output section can output background music based on the background music data, the voice of people and/or the sound of surrounding based on the audio data of the movie data and various sounds. In certain embodiments, the user can confirm the background music by reproducing the background music data from the sound output section before the user decides the background music data by the selecting section. Examples of the sound output section consistent with certain embodiments of the invention include, but are not limited to, a speaker. In certain embodiments, the sound output section can be means for outputting background music data, audio data and/or the various sound (in other words, sound outputting means).

In certain embodiments, the digital photo album producing apparatus can comprise a displaying section. In certain embodiments, the displaying section can display still image based on the still image data of the image data, movie based on the movie data of the image data and various instructions, messages and/or images. Examples of the displaying section consistent with certain embodiments of the invention include, but are not limited to, a liquid crystal display (LCD), a Braun tube, a cathode ray tube (CRT) and a plasma display panel. In certain embodiments, the data input section and/or the selecting section can be combined with the displaying section as one component (e.g., the touch panel on the display). In certain embodiments, the displaying section can be means for displaying image data and/or various image (in other words, displaying means).

In certain embodiments, the digital photo album producing apparatus can comprise a verification section. In certain embodiments, the verification section can verify whether the removable digital information recording medium to be used for recording the digital photo album file is an authorized medium or not. In certain embodiments, only if the verification section judges that the removable digital information recording medium is the authorized medium, the verification section can allow the recording section to record the digital photo album file produced by the producing section onto the verified removable digital information recording medium. In certain embodiments, if the verification section judges that the removable digital information recording medium is not the authorized medium, the verification section can prohibit the recording section from recording the digital photo album file. In certain embodiments, the removable digital information recording medium which records correct authorized data (e.g., an authorized seal, an authorized signal, an authorized code, a manufacture code, a password, an ID and the like) can be regarded as the authorized medium. In certain embodiments, the removable digital information recording medium in which the correct authorized data is stamped beforehand can be regarded as the authorized medium. For instance, in the case that the manufacture code is used as the authorized data, same manufacture code can be stamped on all of the removable digital information recording medium which are manufactured by the same manufacturer. In certain embodiments, the correct authorized data can be stored in the data storing section beforehand, then the verification section can compare the authorized data recorded or stamped in the removable digital information recording medium which is inserted into the digital photo album producing apparatus with the authorized data stored in the data storing section or can confirm whether the same data with the authorized data stored in the data storing section is recorded or stamped in the removable digital information recording medium. In certain embodiments, only if the verification section judges that the authorized data recorded or stamped in the removable digital information recording medium is consistent with the authorized data stored in the data storing section or finds the same data with the authorized data stored in the data storing section from the removable digital information recording medium, the verification section can regard such removable digital information recording medium as the authorized medium. Examples of the verification section consistent with certain embodiments of the invention include, but are not limited to, a central processing unit (CPU) or a micro processing unit (MPU), with a memory and software for verification, if necessary. In certain embodiments, the verification section can be means for verifying whether the removable digital information recording medium is authorized or not (in other words, verifying means).

In certain embodiments, the calculating section can calculate temporal total reproducing time of the image data and compare the temporal total reproducing time of the image data with reproducing time of the background music data selected by the selecting section.

In certain embodiments, the calculating section can calculate temporal reproducing time of each still image data based on the reproducing time of the background music data selected by the selecting section, the number of the still image data and the reproducing time of the movie data. For instance, the temporal reproducing time of each still image data can be calculated by subtracting the reproducing time of the movie data from the reproducing time of the background music data at first and dividing the result of the subtraction by the number of still image data.

In certain embodiments, after the calculation of the temporal reproducing time of each still image data, the calculating section can compare the temporal reproducing time of each still image data with the time of the minimum time data and the time of the maximum time data to decide the reproducing time of each still image data. In certain embodiments, if the calculating section judges that the temporal reproducing time of each still image data is less than the time of the minimum time data stored in the data storing section, the time of the minimum time data stored in the data storing section can be set as the reproducing time of each still image data by the calculating section. In certain embodiments, if the calculating section judges that the temporal reproducing time of each still image data is more than the time of the maximum time data stored in the data storing section, the time of the maximum time data stored in the data storing section can be set as the reproducing time of each still image data by the calculating section. In certain embodiments, if the calculating section judges that the temporal reproducing time of each still image data is not more than the time of the maximum time data and not less than the time of the minimum time data, the temporal reproducing time can be set as the reproducing time of each still image data by the calculating section.

In certain embodiments, after deciding the reproducing time of each still image data, the calculating section can calculate temporal total reproducing time of the image data based on the decided reproducing time of each still image data, the number of the still image data, the reproducing time of the movie data. For instance, the temporal total reproducing time of the image data can be calculated by multiplying the reproducing time of each still image data by the number of the still image data and adding the reproducing time of the movie data to the result of the multiplication.

In certain embodiments, after the calculation of the temporal total reproducing time of the image data, the calculating section can compare the temporal total reproducing time of the image data with the reproducing time of the background music data to decide the total reproducing time of the digital photo album file. In certain embodiments, if the calculating section judges that the temporal total reproducing time of the image data is longer than the reproducing time of the background music data selected by the selecting section, the temporal total reproducing time of the image data can be set as the total reproducing time of the digital photo album file by the calculating section. In certain embodiments, if the calculating section judges that the temporal total reproducing time of the image data is shorter than the reproducing time of the background music data, the reproducing time of the background music data can be set as the total reproducing time of the digital photo album file by the calculating section.

In certain embodiments, the calculating section can calculate the temporal reproducing time of each still image data, the reproducing time of each still image data, the temporal total reproducing time of the digital photo album file or the total reproducing time of the digital photo album file by utilizing a frame, not sec. or min., as an unit for the calculation. In certain embodiments, the frame can be an unit indicating how many sequential images are displayed during predetermined period (e.g., 1 sec.). For instance, if it is decided by certain format (e.g., video CD format, DVD format etc.) that 30 frames can be displayed during 1 sec., 10 sec. can be processed as 300 frames. In certain embodiments, the frame data (e.g., information about how many images are displayed during the predetermined period) can be stored in the data storing section.

Examples of the calculating section consistent with certain embodiments of the invention include, but are not limited to, a CPU or a MPU, with a memory and/or software for the calculation, if necessary. In certain embodiments, the calculating section can be means for calculating temporal total reproducing time of the image data and comparing the temporal total reproducing time with the reproducing time of the background music data (in other words, calculating means).

In certain embodiments, the processing section can produce the digital photo album file based on the image data and the background music data. In certain embodiments, the processing section can produce the digital photo album file based on the reproducing time of each still image data and the total reproducing time of the digital photo album file. The way to produce the digital photo album file is described later. In certain embodiments, the processing section can produce one digital photo album file by mixing and compressing the background music data and the image data comprising the still image data and/or the movie data having the audio data. In certain embodiments, the processing section can produce the digital photo album file by mixing and compressing the background music data and the image data so that the reproducing of the image data can start with the reproducing of the background music data. In certain embodiments, the processing section can produce the digital photo album file by compressing the background music file and the image data according to compression algorithm. For instance, if the CD (e.g., CD-R, CD-RW etc.) is used as the removable digital information recording medium, the compression algorithm can be MPEG-1. If the DVD (e.g., DVD-R, DVD-RW, DVD+RW etc.) is used as the removable digital information recording medium, the compression algorithm can be MPEG-2.

In certain embodiments, the processing section can compress the still image data whose format is JPEG format or other format according to the compression algorithm and can convert the still image data into certain compression format. Further, the processing section can compress the background music data whose format is WAVE format or other format according to the compression algorithm and can convert the background music data into the compression format. The processing section can divide the movie data whose format is AVI format, MOV format or other format into the audio data and the movie data not including the audio data at first, then can compress the audio data whose format is AVI format, MOV format or other format according to the compression algorithm and can convert the audio data into the compression format, and can compress the movie data not including the audio data, whose format is AVI format, MOV format or other format according to the compression algorithm and can convert the movie data not including the audio data into the compression format. After that, the processing section can mix the still image data, the movie data not including the audio data, the background music data and the audio data, whose formats are the compression format into one digital photo album file according to the video image related format (e.g., video CD format, DVD format etc.).

In certain embodiments, the processing section can produce the digital photo album file based on the total reproducing time of the digital photo album file calculated by the calculating section.

In certain embodiments, the digital photo album file can be a video file so that the still image data and/or the movie data can be reproduced sequentially with the reproducing of the background music data. In certain embodiments, the digital photo album file can comprise several segments. In certain embodiments, each segment can comprise one or several still image data to be reproduced sequentially. In certain embodiments, each segment can comprise one or several movie data to be reproduced sequentially. In certain embodiments, one segment can be composed of only still image data or only movie data and may not comprise both of still image data and movie data.

In certain embodiments, if the calculating section judges that the temporal total reproducing time of the image data is longer than the reproducing time of the background music data, the processing section can produce the digital photo album file so that the background music file is reproduced repeatedly until the reproducing of the images data ends. In certain embodiments, if the calculating section judges that the temporal total reproducing time of the image data is shorter than reproducing time of the background music data, the processing section can produce the digital photo album file so that the image data is reproduced repeatedly until the reproducing of the background music data ends. In certain embodiments if the calculating section judges that the temporal total reproducing time of the image data is longer than the reproducing time of the background music data, the processing section can produce the digital photo album file so that the background music data is reproduced repeatedly until the reproducing of the image data ends and when the reproducing of the image data ends, the background music is faded out.

In certain embodiments, the processing section can produce the digital photo album file so that the background music data is reproduced only during the reproducing of the image data. In certain embodiments, the processing section can produce the digital photo album file so that the audio data included in the movie data is reproduced only during the reproducing of the movie data. In certain embodiments, the processing section can produce the digital photo album file so that while both of the background music data and the audio data are reproduced simultaneously, the background music data can be reproduced by using only one channel (e.g., a left channel or a right channel) of two stereo channels and the audio data can be reproduced by using only the other channel (e.g., a right channel or a left channel) of the two stereo channels. In certain embodiments, the processing section can produce the digital photo album file so that while the background music data is reproduced without the reproducing of the audio data, the background music data can be reproduced by using the two stereo channels. In certain embodiments, the processing section can produce the digital photo album file so that while both of the background music data and the audio data are reproduced simultaneously, the audio data can be reproduced at higher level than level of the reproducing of the background music data. For instance, if the level of the reproducing of the audio data is 100, the level of the reproducing of the background music data can be from 50 to 80. In certain embodiments, the processing section can produce the digital photo album file so that when it is changed from the status of the reproducing of the background music data with the reproducing of the audio data to the status of the reproducing of the background music data without the reproducing of the audio data or in reverse thereof, the level of the reproducing of the background music data can be gradually changed.

In certain embodiments, the processing section can produce the digital photo album file so that the resolution of the still image data can be higher than the resolution of the movie data. For instance, the resolution of the still image data can be 704×480 and the resolution of the movie data can be 352×240.

Examples of the processing section consistent with certain embodiments of the invention include, but are not limited to, a CPU or a MPU, with a memory and/or software for producing the digital photo album file, if necessary. In certain embodiments, the processing section can be means for producing the digital photo album file (in other words, digital photo album file producing means).

In certain embodiments, at least two of the calculating section, the processing section and the verification section can be one same component. In certain embodiments, the calculating section, the processing section and the verification section can be different components.

Producing a Digital Photo Album File

In certain embodiments, the maximum time and the minimum time for displaying each still image data can be established and be stored in the data storing section as the maximum time data and the minimum time data in advance. In certain embodiments, it is preferable that the maximum time can be from 5 sec. to 30 sec.. In certain embodiments, it is preferable that the minimum time can be 1 sec. to 5 sec.. For instance, 5 sec. can be stored as the minimum time data and 20 sec. can be stored as the maximum time data in the data storing section in advance.

In certain embodiments, one or several background music data can be stored in the data storing section in advance. In certain embodiments, the authorized data for verification can be stored in the data storing section in advance. In certain embodiments, the frame data can be stored in the data storing section in advance.

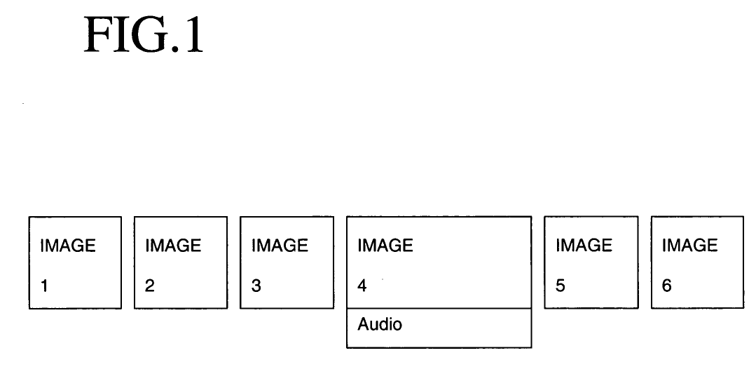

In certain embodiments, an user can take digital photograph and/or digital movie by the digital camera (e.g., a digital still camera and a digital video camera) and store the digital photograph and/or the digital movie in the image data recording medium. In certain embodiments, the image data recording medium storing the image data comprising the still image data, whose format is JPEG format, or other format and/or the movie data, whose format is AVI format, MOV format or other format, having the audio data can be inserted into the reading section of the digital photo album producing apparatus. In certain embodiments, the image data can be read from the inserted image data recording medium by the reading section and the read image data can be stored in the image data storing section temporally. For instance, as illustrated in FIG. 1, the image data comprising five still image data (IMAGE 1, 2, 3, 5 and 6) and one movie data including audio data (IMAGE 4) of which reproducing time is 1 min. can be read from the image data recording medium and be stored in the image data storing section temporally. In certain embodiments, if several kinds of data is stored in the image data recording medium, only standard image related file can be obtained by the reading section.

In certain embodiments, the image data stored in the image data storing section can be read and the still images and the movie (or one still image extracted from the movie) generally corresponding to the image data can be displayed on the displaying section. In certain embodiments, all of the still images and the movie can be displayed on one screen like thumbnail in the displaying section. In certain embodiments, several still images and/or the movie can be displayed in one page like thumbnail on the displaying section and other still images and/or the movie can be displayed in another page on the displaying section.

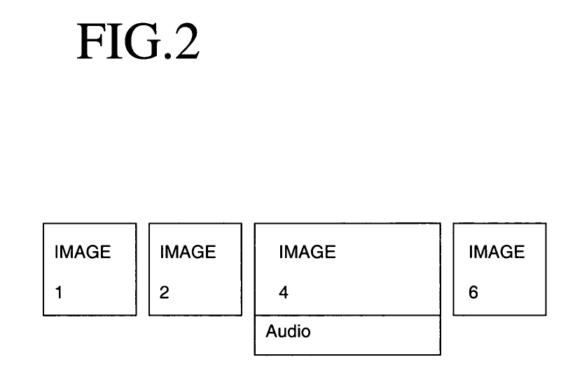

In certain embodiments, the image data which the user wants to include in the digital photo album file or the image data which the user does not want to included in the digital photo album can be selected by the operation of the user from the selecting section or the data input section as the user sees the still images and/or the movie displayed on the displaying section. For instance, as illustrated in FIG. 2, the IMAGE 1, 2, 6 of the still image data and the IMAGE 4 of the movie data can be selected as the image data to be included in the digital photo album file.

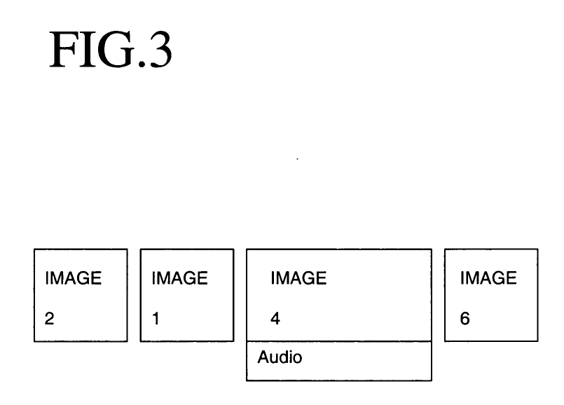

In certain embodiments, the user can change order of the reproducing of the still image data and/or the movie data by the operation of the user from the data input section. For instance, as illustrated in FIG. 3, the order of reproducing image data can be changed from the order of IMAGE 1, 2, 4 and 6 to the order of IMAGE 2, 1, 4 and 6 according to the user's operation input by the data input section. In certain embodiments, the user can change an orientation (e.g., a horizontal, a vertical and the like) of the still image and/or the movie by the operation of the user input by the data input section.

In certain embodiments, reference information (e.g., a title, an artist, a reference number and the like) of the background music data stored in the data storing section can be displayed on the displaying section. In certain embodiments, the user can select background music data by the selecting section among the background music data stored in the data storing section as the user sees the reference information displayed on the displaying section. In certain embodiments, the background music data can be reproduced from the sound output section for a predetermined period and the user can select the background music data after the user listens to the background music. For instance, the user can select BGM No. 3 of which the reproducing time is 3 min. 42 sec. among six background music data by the selecting section after listening to each of the background music.

In certain embodiments, the reproducing time of the image data can be calculated by the calculating section. In certain embodiments, the temporal reproducing time of each still image data can be calculated by the calculating section. Then, the reproducing time of each still image data can be decided by comparing the temporal reproducing time with the time of the maximum time data and the time of the minimum time data stored in the data storing section. The detail of the calculation is also described in the above APPARATUS section. For instance, at first, the calculating section can subtract 1 min. which is reproducing time of the movie data (IMAGE 4) from 3 min. 42 sec. which is the reproducing time of the background music data (BGM No.3). The result of the subtraction is 2 min. 42 sec. Then, the 2 min. 42 sec. can be divided by 3 which is the number of still image data (IMAGE 2, 1 and 6). The result of the division is 54 sec. The 54 sec. is the temporal reproducing time of each still image data. Because the calculating section can judge that the temporal reproducing time of each still image (54 sec.) is more than the time of the maximum time data (20 sec.) stored in the data storing section by comparing the temporal reproducing time with the time of the maximum time data and the time of the minimum time data, the maximum time (20 sec.) can be set as the reproducing time of each still image data by the calculating section.

In certain embodiments, after the reproducing time of each still image data is decided, the temporal total reproducing time of the image data can be calculated by the calculating section. Then, the total reproducing time of the digital photo album file can be decided by comparing the temporal total reproducing time of the image data with the reproducing time of the background music. For instance, after 20 sec. is decided as the reproducing time of each still image data, the temporal total reproducing time of the image data can be calculated by the calculating section. Because the reproducing time of each still image is 20 sec., the number of the still image data is 3 (IMAGE 2, 1 and 6) and the reproducing time of the movie is 1 min. (IMAGE 4), the temporal total reproducing time of the image data is 2 min. (20 sec.×3+1 min.=2 min.). Because the 2 min. is shorter than 3 min. 42 sec. which is the reproducing time of the background music data (BGM No. 3), the 3 min. 42 sec. can be set as the total reproducing time of the digital photo album by the calculating section. Therefore, the total reproducing time of the digital photo album file can be 3 min. 42 sec.

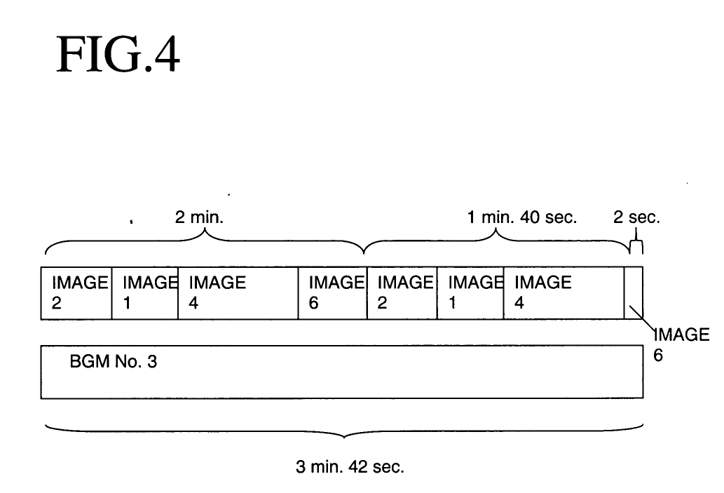

In certain embodiments, after the total reproducing time of the digital photo album file is decided by the calculating section, an outline of the digital photo album file can be decided by the calculating section and/or the processing section. In certain embodiments, the outline of the digital photo album file can include the order of displaying each still image data and/or the movie data, the total reproducing time of the digital photo album file, the reproducing time of each still image data and/or the movie data, the reproducing time of the background music data, how many times the background music data or the image data is reproduced repeatedly and the like. In certain embodiments, the outline can further include the orientation of each still image data and/or the movie data, the kind of the background music data. For instance, as illustrated in FIG. 4, the outline of the digital photo album file can be decided so that the image data can be reproduced repeatedly until the reproducing of the background music ends because the reproducing time (3 min. 42 sec.) of the background music data is longer than the temporary total reproducing time (2 min.) of the image data. The difference between the reproducing time (3 min. 42 sec.) of the background music (BGM No.3) and the temporary total reproducing time (2 min.) of the image data (IMAGE 2,1, 4 and 6) is 1 min. 42 sec. During the 1 min. 42 sec., IMAGE 2, 1, and 4 can be reproduced fully again, because the reproducing time of IMAGE 2 is 20 sec., the reproducing time of IMAGE 1 is 20 sec and the reproducing time of IMAGE 4 is 1 min. After the IMAGE 2, 1 and 4 is reproduced again, the rest of the reproducing time is 2 sec. Therefore, as illustrated in FIG. 4, the processing section and/or the calculating section can decide the outline of the digital photo album file so that the IMAGE 2, 1 and 4 can be reproduced fully again and only 2 sec. of the IMAGE 6 can be reproduced after the IMAGE 2, 1, 4 and 6 is reproduced once.

In certain embodiments, if the user selects that the background music is not reproduced (no background music), the calculation of the temporal reproducing time of each still image data is not required and the minimum time data or the maximum time data can be set as the reproducing time of each still image data arbitrarily. Further, the calculation of the temporal total reproducing time of the digital photo album file is not required. Then, the total reproducing time of the digital photo album file can be calculated by multiplying the reproducing time of each still image data by the number of the still image data and adding the result of the multiplying to the reproducing time of the movie data.

In certain embodiments, the above calculation can be conducted by utilizing a frame as an unit, not time (e.g., sec. and min. etc.). For instance, in the above embodiments, if 30 frames can be reproduced during 1 sec., the data recording section can record that 1 sec. is equal to 30 frames in advance, and the minimum time data can be stored as 150 frames (30 frames×5 sec.), the maximum time data can be stored as 600 frames (30 frames×20 sec.). Further, the temporal reproducing time of each still image data can be obtained as 1620 frames (30 frames×54 sec.) and the reproducing time of each still image data can be obtained as 600 frames. Further, the reproducing time of the movie data can be 1800 frames. The temporal total reproducing time of the digital photo image file can be 3600 frames. The total reproducing time of the digital photo image file can be 6660 frames. The reproducing time of the second IMAGE 6 can be 60 frames. By utilizing frames for the calculation, smaller unit than sec. can be utilized, the reproducing time can be controlled in more detail and decimal calculation can be avoided more.

In certain embodiments, if the reproducing time of the still image data which is reproduced at the last of the digital photo album file (e.g., second IMAGE 6 of FIG. 4) is less than the reproducing time of other still image data, the digital photo album file can be produced so that the last still image data might not be included in the digital photo album file and the background music can be faded out and ended synchronizing with the end of the reproducing of the image data which is just before the last still image data (e.g., second IMAGE 6 of FIG. 4). In certain embodiments, if the reproducing time of the movie data which is reproduced at the last of the digital photo album file is less than the reproducing time of the original movie data, the digital photo album file can be produced so that the last movie data might not be included in the digital photo album file and the background music can be faded out and ended synchronizing with the end of the reproducing of the image data which is just before the last movie data.

In certain embodiments, after the outline of the digital photo album file is decided, the digital photo album file can be produced by the processing section. In certain embodiments, the deciding process of the outline of the digital photo album file and the producing process of the digital photo album file can be separate process. In certain embodiments, the deciding process of the outline of the digital photo album file and the producing process of the digital photo album file can be consolidated. In certain embodiments, the digital photo album file can be produced by mixing and compressing the background music data and the image data comprising the still image data and/or the movie data including the audio data into one video file according to the algorithm of data compression (e.g., MPEG-1, MPEG-2) so that the reproducing of the image data can start with the reproducing of the background music data and the reproducing of the image data can end with the reproducing of the background music data.

In certain embodiments, the still image data whose format is JPEG format or other format can be compressed according to the compression algorithm and can be converted into certain compression format. Further, the background music data whose format is WAVE format or other format can be compressed according to the compression algorithm and can be converted into the compression format. The movie data whose format is AVI format, MOV format or other format can be divided into the audio data and the movie data not including the audio data at first, then the audio data whose format is AVI format, MOV format or other format can be compressed according to the compression algorithm and can be converted into the compression format, and the movie data not including the audio data, whose format is AVI format, MOV format or other format can be compressed according to the compression algorithm and can be converted into the compression format. After that, the still image data, the movie data not including the audio data, the background music data and the audio data, whose formats are the compression format can be mixed into one digital photo album file according to the video image related format (e.g., video CD format, DVD format etc.). In certain embodiments, the image data can be compressed so that the resolution of the still image data is higher than the resolution of the movie data. For instance, the resolution of the still image data can be 704×480 and the resolution of the movie data can be 352×240.

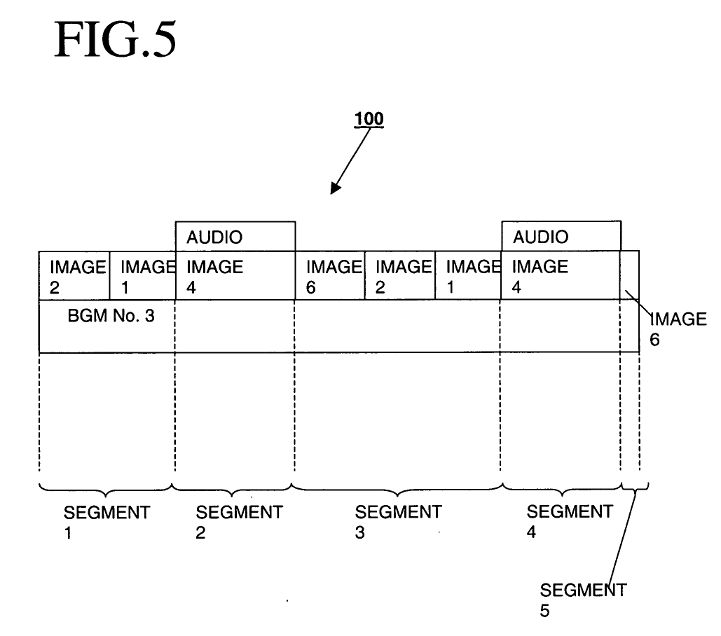

For instance, as illustrated in FIG. 5, the digital photo album file 100 can be produced by compressing the background music data (BGM No. 3 whose format is WAVE format) and the image data comprising the still image data (IMAGE 2, 1 and 6 whose formats are JPEG file), the movie data (IMAGE 4 whose format is AVI format) including the audio data (AUDIO whose format is AVI format) according to the algorithm of compression (e.g., MPEG-1) and mixing into one video file according to the video image related format (e.g., video CD format) so that the 20 sec. of each of the IMAGE 2, 1, 4 and only 2 sec. of the IMAGE 6 can be reproduced again after the IMAGE 2, 1, 4 and 6 is reproduced fully once, and the reproducing of the first IMAGE 2 can start with the reproducing of the BGM No. 3 and the reproducing of the second IMAGE 6 can end with the reproducing of the BGM No. 3. The digital photo album file 100 can comprise 5 segments (SEGMENT 1, 2, 3, 4, and 5). In certain embodiments, each segment can be comprised of only one or more still image data, or only one or more movie data. In certain embodiments, each segment might not comprise both of still image data and movie data. In certain embodiments, the background music data can be divided into several parts so that each part can be included in each segment of the digital photo album file. As illustrated in FIG. 5, the SEGMENT 1 can comprise IMAGE 2 and 1 (still image data) and first part of BGM No. 3. The SEGMENT 2 can comprise IMAGE 4 (movie data) including AUDIO (audio data) and second part of BGM No. 3. The SEGMENT 3 can comprise IMAGE 6, 2 and 1 (still image data) and third part of BGM No. 3. The SEGMENT 4 can comprise IMAGE 4 (movie data) including AUDIO (audio data) and fourth part of BGM No. 3. The SEGMENT 5 can comprise IMAGE 6 (still image data) of which reproducing time is only 2 sec. and fifth (final) part of BGM No. 3.

In certain embodiments, the digital photo album file can be produced so that while the background music data and the audio data are reproduced simultaneously, the background music data can be reproduced by using only one channel (e.g., a left channel or a right channel) of two stereo channels and the audio data can be reproduced by using only the other channel (e.g., a right channel or a left channel) of the two stereo channels. In certain embodiments, the digital photo album file can be produced so that while the background music data is reproduced without reproducing of the audio data, the background music data can be reproduced by using the two stereo channels. In certain embodiments, the digital photo album file can be produced so that while the background music data and the audio data are reproduced simultaneously, the audio data can be reproduced at higher level than level of the background music data. For instance, as illustrated in FIG. 5, the digital photo album file 100 can be produced so that while each of SEGMENT 1, 3, and 5 is reproduced, the background music data (BGM No. 3) can be reproduced by using the two stereo channels. While each of SEGMENT 2 and 4 is reproduced, the background music data (BGM No. 3) can be reproduced by using only the left channel and the audio data (AUDIO) can be reproduced by using only the right channel at higher level (e.g., Level 100) than the level of the left channel (e.g., Level 60). In certain embodiments, as illustrated in FIG. 5, if the digital photo album file 100 is reproduced, the reproducing of the still image data (IMAGE 2) can start with the reproducing of the background music data (BGM No.3) simultaneously.

In certain embodiments, the user can input a reference information (e.g., a title, a place of photo, a name of man and so on) of the digital photo album file by the data input section. In certain embodiments, the processing section can produce the digital photo album file so that the reference information is included in the digital photo album file.

In certain embodiments, the user can insert the removable digital information recording medium into the recording section of the digital photo album producing apparatus.

In certain embodiments, the removable digital information recording medium inserted into the digital photo album producing apparatus can be verified by the verification section whether the inserted removable digital information recording medium is authorized to record the digital photo album file or not. In certain embodiments, the verification can be conducted by confirming whether the authorized data is recorded or stamped in the removable digital information recording medium or not. In certain embodiments, the authorized data recorded or stamped in the removable digital information recording medium which is inserted into the digital photo album producing apparatus can be compared with the authorized data stored in the data storing section. If it is judged that the authorized data recorded or stamped in the removable digital information recording medium is consistent with the authorized data stored in the data storing section, such removable digital information recording medium can be regarded as the authorized medium. In certain embodiments, if the verification section judges that the removable digital information recording medium is not authorized, certain message such as “THIS MEDIUM IS NOT AUTHORIZED TO RECORD DIGITAL PHOTO ALBUM. SO, PLEASE INSERT AN AUTHORIZED MEDIUM INTO THE MACHINE.” can be displayed on the displaying section and the non-authorized removable digital information recording medium can be put out from the digital photo album producing apparatus.

In certain embodiments, if it is verified that the inserted removable digital information recording medium is authorized, the digital photo album file can be recorded onto the removable digital information recording medium by the recording section according to the video image related format (e.g., video CD format, DVD format etc.). In certain embodiments, the original image data (in other words, raw data) originally stored in the image data recording medium can be recorded onto the removable digital information recording medium in addition to the digital photo album file by the recording section. In certain embodiments, after finishing the recording, the removable digital information recording medium can be put out from the digital photo album producing apparatus.

In certain embodiments, after finishing the recording or after finishing the producing the digital photo album file, the image data stored in the image data storing section can be deleted.

### EXAMPLE

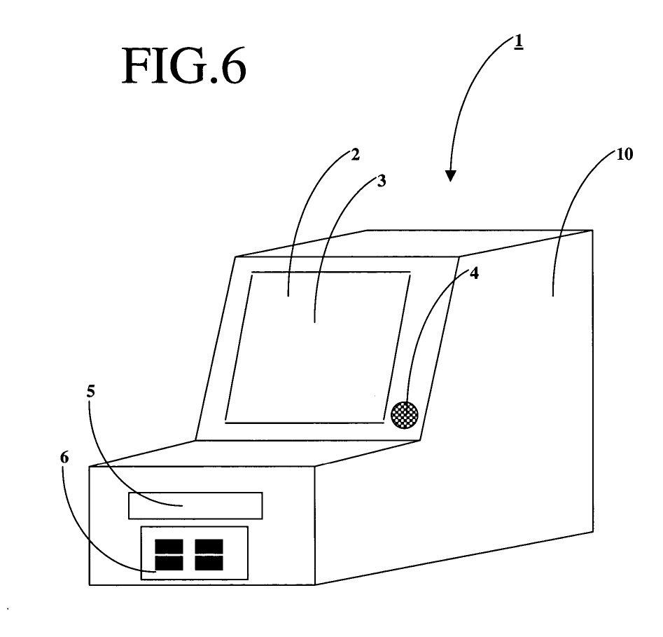

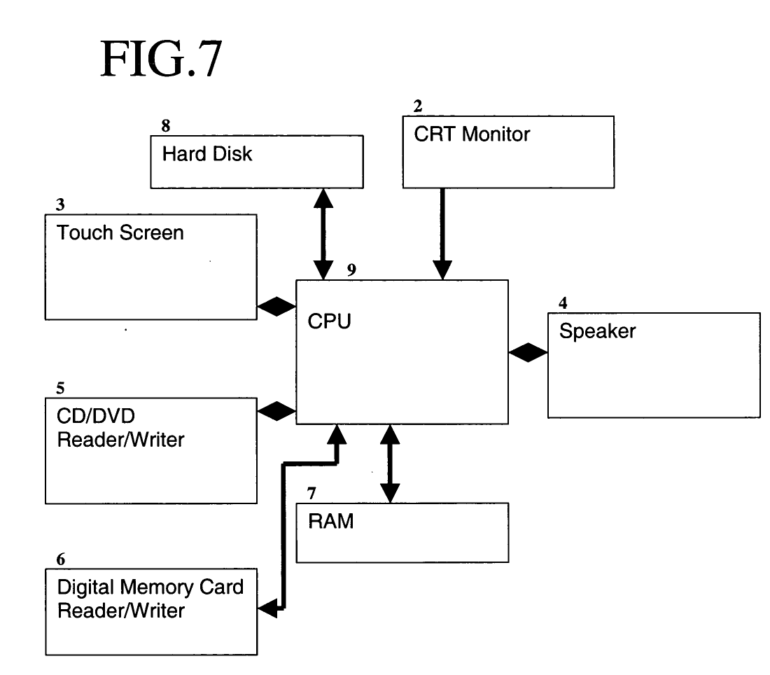

In certain embodiments, as illustrated in FIG. 6, the digital photo album producing apparatus (e.g. Photo Kiosk 1) can comprise a case 10, a displaying section (e.g., a CRT monitor 2), a selecting section and a data input section (e.g., a touch screen 3 as both of the selecting section and the data input section), a sound output section (e.g., a speaker 4), a reading section and a recording section (e.g., a CD/DVD reader/writer 5 and a digital memory card reader/writer 6 as both of the reading section and the recording section). In certain embodiments, the digital memory card reader/writer 6 can read and/or write digital data from and/or onto a Memory Stick, a Compact Flash, a SD memory card, and a Smart Media. In certain embodiments, as illustrated in FIG. 7, the Photo Kiosk 100 can further comprise an image data storing section and a data storing section (e.g., a hard disk 8 as both of the image data storing section and the data storing section) and a calculating section, a processing section and a verification section (e.g., a CPU 9 and a RAM 7 with software as all of the calculating section, the processing section and the verification section). In certain embodiments, the CPU 9 can control timing of action, operation, start and stop of action of all of the sections which connect with the CPU 9 according to various software stored in the hard disk 8 or the RAM 7.

In certain embodiments, the maximum time data (e.g., 20 sec.) and the minimum time data (e.g., 5 sec.) for reproducing each still image data can be established and be stored in the hard disk 8 as the data storing section in advance.

In certain embodiments, the background music data of six background music (BGM No. 1, 2, 3, 4, 5 and 6) can be stored in the hard disk 8 as the data storing section in advance. In certain embodiments, the format of the background music data stored in the hard disk 8 can be WAVE format.

In certain embodiments, the correct manufacturing code (e.g., 34567) as the authorized data can be stored in the hard disk 8 as the data recording section beforehand.

In certain embodiments, an user can take digital photograph and/or digital movie by the digital camera and store the still image data and/or the movie data in the image data recording medium (e.g., a SD memory card). In certain embodiments, the SD memory card storing the image data including the still image data (e.g., IMAGE 1, 2, 3, 5 and 6) and the movie data (e.g., IMAGE 4 of which reproducing time is 1 min.) having the audio data can be inserted into the digital memory card reader/writer 6 as the reading section. In certain embodiments, the format of the still image data stored in the SD memory card can be JPEG format. In certain embodiments, the format of the movie data stored in the SD memory card can be AVI format. In certain embodiments, the still image data whose format is JPEG format and the movie data whose format is AVI format can be included in the file under DCIM directory recorded in the SD memory card. In certain embodiments, the SD memory card can store Microsoft Word file in addition to the image data. In certain embodiments, the memory card reader/writer 6 can read only the image data (e.g., IMAGE 1, 2, 3, 4, 5 and 6) included in the file under DCIM directory from the SD memory card and the image data (e.g., IMAGE 1, 2, 3, 4, 5 and 6) whose formats are same with original image data can be stored in the hard disk 8 as the image data storing section temporally.

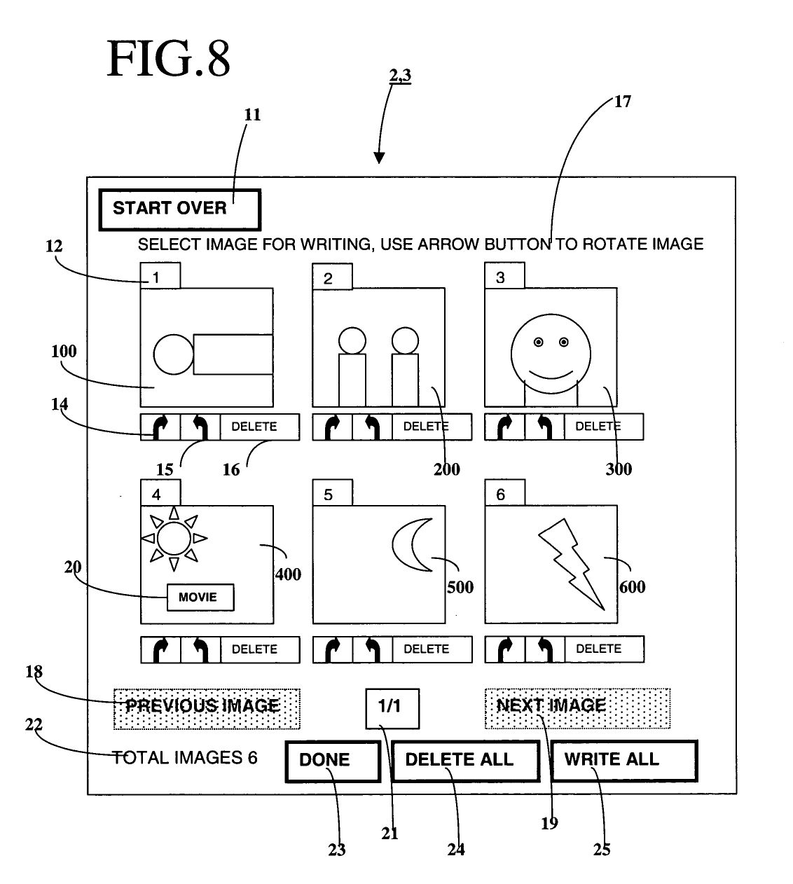

In certain embodiments, as illustrated in FIG. 8, the IMAGE 1, 2, 3, 4, 5 and 6 can be read from the hard disk 8 and the still images generally corresponding to IMAGE 1 (100), 2 (200), 3 (300), 5 (500) and 6 (600) and the still image of beginning of the movie data of IMAGE 4 (400) can be displayed on the CRT monitor 2.

In certain embodiments, an instruction message 17 can be displayed on the CRT monitor 2. In certain embodiments, a reference number 12 of each image data can be displayed above each of the image on the CRT monitor 2. In certain embodiments, a page number 21 can be displayed on the CRT monitor 2. As illustrated in FIG. 8, 1/1 shows that the total number of all pages for displaying the image data is 1 and page 1 is now displayed. In certain embodiments, total number of image data 22 can be displayed on the CRT monitor 2. In certain embodiments, a movie mark 20 can be displayed within the still image 400 of the beginning of the movie data on the CRT monitor 2 to show the image data is the movie data.

In certain embodiments, a START OVER button 11 to start over the process of the producing the digital photo album can be displayed on the CRT monitor 2. If an user touches the portion of the touch screen 3 as the data input section corresponding to the START OVER button 11, the user can start over the process of the producing of the digital photo album from the beginning.

In certain embodiments, page change buttons 18, 19 can be displayed on the CRT monitor 2. If an user touches the portion of the touch screen 3 corresponding to the page change button 18, 19, the page displaying the image data can be changed. If the user touches the page change button of “PREVIOUS IMAGE” 18, a page displayed on the CRT monitor 2 will go back to the previous page. If the user touches the page change button of “NEXT IMAGE” 19, a page displayed on the CRT monitor 2 will go forward to the next page. As illustrated in FIG. 8, because the total number of image data is six and the number of the displaying page is only one, the page change button is unnecessary in this embodiment and the displayed page change buttons 18, 19 are fuzzy.

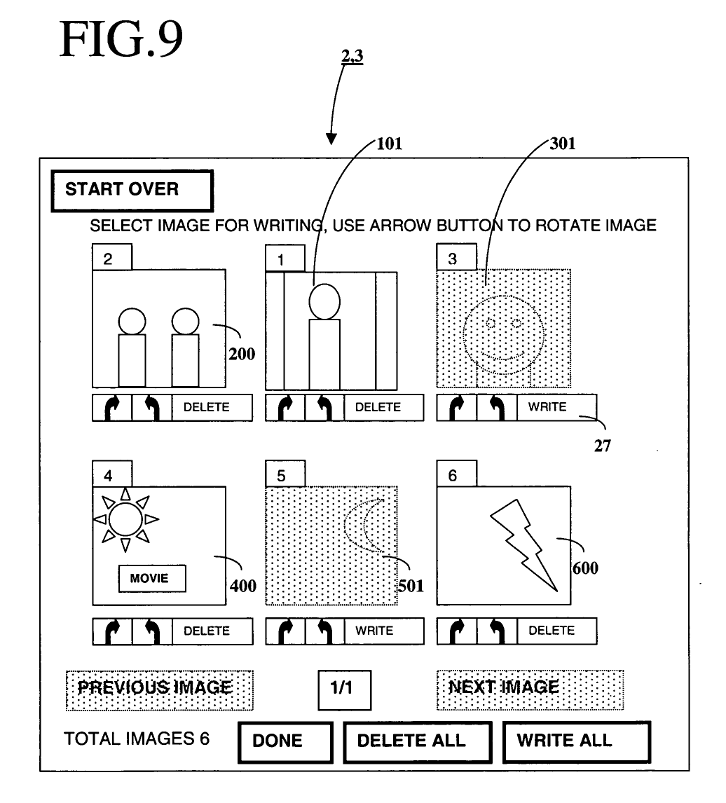

In certain embodiments, if the user touches the portion of the touch screen 3 corresponding to each image (100, 200, 300, 400, 500, 600) and drug, the user can change the order of the reproducing of the image data. As illustrated in FIG. 9, if the user touches the portion of the touch screen 3 corresponding to the IMAGE 1 (100) and drug to the place between the IMAGE 2 (200) and IMAGE 3 (300), the order of the reproducing of the image data changes and the first image to be reproduced becomes IMAGE 2 (200) and the second image to be reproduced becomes the IMAGE 1 (101).

In certain embodiments, image rotation buttons 14, 15 can be displayed below each image on the CRT monitor 2. If an user touches the portion of the touch panel 3 corresponding to the image rotation buttons 14, 15, the image which corresponding to the image rotation buttons can be rotated by 90 degrees. As illustrated in FIG. 9, if the user touches the right rotation button 14, the IMAGE 1 (101) can be displayed in the status rotated by 90 degrees clockwise. If user touches the left rotation button 15, the IMAGE 1 (100) can be rotated by 90 degrees counterclockwise.

In certain embodiments, image deleting buttons 16 can be displayed below each image on the CRT monitor 2. If an user does not want to include certain image data in the digital photo album file, the user can touch the portion of the touch screen 3 corresponding to the image deleting button 16 which is below the image which the user does not want to include and the image data can be prohibited from being included in the digital photo album file. As illustrated in FIG. 9, if the user touches the portion of the touch screen 3 corresponding to the image deleting button 16 below the IMAGE 3 and 5 (300, 500) which the user does not want to include, the displayed IMAGE 3 and 5 (301, 501) can be fuzzy and IMAGE 3 and 5 can be prohibited from being included in the digital photo album file. If the user wants to include the image data for which the image deleting button has been already touched, the user can touch the image writing button 27 to include the image data in the digital photo album file. As illustrated in FIG. 8, in this embodiment, if user does not touch any image deleting button 16, all of the image data can be included in the digital photo album file.

In certain embodiments, an all image deleting button 24 can be displayed on the CRT monitor 2. If an user touches the portion of the touch screen 3 corresponding to the all image deleting button 24, all of the image data displayed in the current page can be specified as the image data not to be included in the digital photo album file.

In certain embodiments, an all image writing button 25 can be displayed on the CRT monitor 2. If an user touches the portion of the touch panel 3 corresponding to the all image writing button 25, all of the image data displayed in the current page can be specified as the image data to be included in the digital photo album file. In this embodiments, even if the user does not touch the all image writing button 25, it is originally established that all of the image data are included in the digital photo album file.

In certain embodiments, a finish button 23 can be displayed on the CRT monitor 2. If an user touches the portion of the touch screen 3 corresponding to the finish button 23, the process of selecting image, rotating image and changing order of image can be completed, the image data to be included in the digital photo album file, the orientation of image data and the order of image data can be fixed and the next step can start. In certain embodiments, the next step may be the step of selecting the background music data, the step of inputting the reference information of the digital photo album file or the step of producing the digital photo album file.

As illustrated in FIG. 9, in this embodiment, the IMAGE 1, 2, 4 and 6 are selected as the image data to be included in the digital photo album file and the order of the image data is as IMAGE 2, 1, 4 and 6 and the orientation of IMAGE 2, 4 and 6 are horizontal and the orientation of IMAGE 1 is vertical.

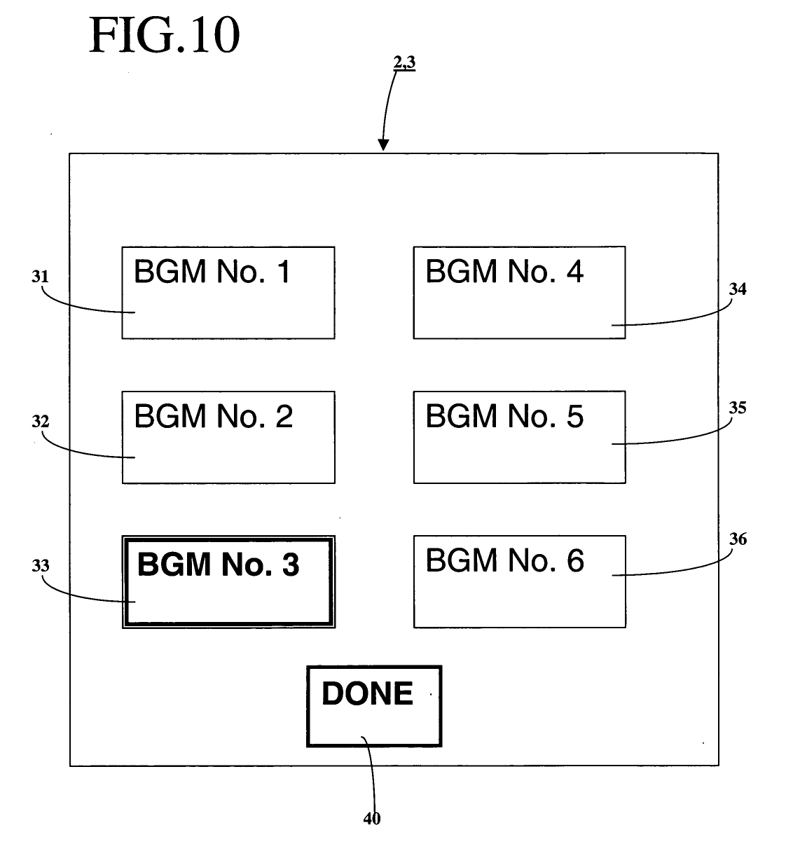

In certain embodiments, as illustrated in FIG. 10, after the user touches the finish button 23, background music buttons (31, 32, 33, 34, 35, 36) for the several background music data (BGM. No. 1, 2, 3, 4, 5 and 6) stored in the hard disk 8 can be displayed on the CRT monitor 2. In certain embodiments, in the background music buttons, the reference number of the background music data as the reference information can be displayed. If an user touches the portion of the touch screen 3 as the selecting section corresponding to each background music button (e.g., 33), the background music (BGM No.3) can be reproduced for predetermined period (e.g., 30 sec.) from the speaker 4 and the user can select the background music data after the user listens to the background music. If the user decides which background music data is selected, the user can touch the background music button (e.g., 33) which is corresponding to the background music data which the user wants to include in the digital photo album file and then touch a finish button 40. If the user touches the finish button 40, the background music data (BGM No. 3) can be fixed.

In certain embodiments, in the next step, as explained in the above PRODUCING A DIGITAL PHOTO ALBUM FILE referring FIG. 4, the CPU 9 as the calculating section with the RAM 7 and the software for calculation can calculate the temporal reproducing time of each still image, the reproducing time of each still image data, the temporal total reproducing time of the image data, the total reproducing time of the digital photo album file.

Then, as explained in the above PRODUCING A DIGITAL PHOTO ALBUM FILE referring FIG. 5, the CPU 9 as the processing section with the RAM 7 and the software for producing the digital photo album file can produce the digital photo album file 100 as one video file based on the still image data of IMAGE 2, 1 and 6, the movie data of IMAGE 4 including the audio data, the background music data of BGM No. 3, order information of IMAGE 2, 1, 4 and 6, orientation information (IMAGE 2, 6 are horizontal orientation and IMAGE 1 is vertical orientation) and the like. In certain embodiments, the still image data (IMAGE 2, 1 and 6) whose format is JPEG format can be compressed according to MPEG-1 format and can be converted into MPEG-1 format (in other words, I-Frame). In certain embodiments, the resolution of the compressed still image data can be 704×480. In certain embodiments, the background music data (BGM No.3) whose format is WAVE format can be compressed according to MPEG-1 layer 2 and can be converted into MPEG-1 layer 2 format. In certain embodiments, the movie data (IMAGE 4 and AUDIO) whose format is AVI format can be separated into the audio data (AUDIO) and the movie data (IMAGE 4) not including the audio data at first, then the audio data (AUDIO) whose format is AVI format can be compressed according to MPEG-1 layer 2 and can be converted into MPEG-1 layer 2 format, and the movie data (IMAGE 4) not including the audio data, whose format is AVI format can be compressed according to MPEG-1 and can be converted into MPEG-1 format. In certain embodiments, the resolution of the compressed movie data can be 352×240. After that, the compressed still image data (IMAGE 2, 1 and 6) whose format is MPEG-1 format, the compressed movie data (IMAGE 4) not including the audio data, whose format is MPEG-1 format, the compressed background music data (BGM No. 3) whose format is MPEG-1 layer 2 format and the compressed audio data (AUDIO) whose format is MPEG-1 layer 2 can be mixed into one digital photo album file according to video CD format.

In certain embodiments, the user can input a title of the digital photo album file from the touch screen 3 as the data input section of which corresponding portion to the keyboard displayed on the CRT monitor 2. In certain embodiments, the CPU 9 can produce the digital photo album file so that the title is included in the digital photo album file.

In certain embodiments, the user can insert the CD-R on which the correct manufacturing code (e.g., 34567) is stamped beforehand by the manufacturer into the CD/DVD reader/writer 5 as the recording section.

In certain embodiments, the CD-R inserted into the Photo Kiosk 100 can be verified by the CPU 9 as the verification section with the RAM 7 and the software for the verification whether the CD-R is authorized to record the digital photo album file or not by comparing the manufacturing code (34567) stamped on the CD-R and read by the CD/DVD reader/writer 5 with the manufacturing code (34567) stored in the hard disk 8. In certain embodiments, if the CPU 9 judges that the CD-R is not authorized, certain message such as “THIS MEDIUM IS NOT AUTHORIZED TO RECORD DIGITAL PHOTO ALBUM. SO, PLEASE INSERT AN AUTHORIZED MEDIUM INTO THE MACHINE.” can be displayed on the CRT monitor 2 and the non-authorized CD-R can be put out from the Photo Kiosk 1.

In certain embodiments, if the CPU 9 judges that the manufacturing code stamped on the CD-R is consistent with the manufacturing code stored in the hard disk 8 and it is verified that the inserted CD-R is authorized, the digital photo album file can be recorded onto the CD-R by the CD/DVD reader/writer 5 according to video CD format. In certain embodiments, the original image data (i.e. raw data) (IMAGE 1, 2, 3, 5 and 6 whose formats are JPEG format and IMAGE 4 whose format is AVI format) included in the image data recording medium can be recorded from the hard disk 8 onto the CD-R in addition to the digital photo album file 100 by the CD/DVD reader/writer 5. After recording, the recorded CD-R (in other words, the video CD) can be put out from the Photo Kiosk 1.

In this specification, the term of the image data, the still image data, the movie data, the audio data and the background music data can mean data before mixed, compressed and included in the digital photo album file or data after mixed, compressed and included in the digital photo album file, depending on the context.

Other various embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A digital photo album producing apparatus, comprising:
a reading section which reads image data including at least one of still image data and movie data comprising audio data from an image data recording medium,
an image data storing section which stores image data read by the reading section,
a data storing section which stores at least one background music data,
a selecting section by which an user selects background music based on the background music data stored in the data storing section,
a processing section which produces a digital photo album file based on the image data stored in the image data storing section and the background music data selected by the selecting section,
a recoding section which records the digital photo album file produced by the processing section onto a removable digital information recording medium, and
wherein the processing section produces the digital photo album file so that the background music data is reproduced during reproducing of the image data, and the audio data of the movie data is reproduced during reproducing of the movie data, and
wherein the processing section produces the digital photo album file so that when the background music data and the audio data are reproduced simultaneously, the background music data is reproduced by using only one of two stereo channels and the audio data is reproduced by using only the other of the two stereo channels, and when the background music data is reproduced without reproducing of the audio data, the background music data is reproduced by using both of the two stereo channels.

2. The digital photo album producing apparatus of claim 1, wherein the processing section produces the digital photo album file so that when the background music data and the audio data are reproduced simultaneously, reproducing level of the audio data is higher than reproducing level of the background music file.

3. A digital photo album producing apparatus, comprising:
means for reading image data including at least one of still image data and movie data from an image data recording medium,
means for storing image data read by the reading means and at least one background music data,
means for inputting background music selection among the background music data stored in the storing means,
means for producing a digital photo album file based on the image data stored in the storing means and the background music data selected by the selecting means,
means for recording the digital photo album file produced by the producing means onto a removable digital information recording medium, and
wherein the producing means produces the digital photo album file so that the background music data is reproduced during reproducing of the image data, and the audio data of the movie data is reproduced during reproducing of the movie data, and
wherein the producing means produces the digital photo album file so that when the background music data and the audio data are reproduced simultaneously, the background music data is reproduced by using only one of two stereo channels and the audio data is reproduced by using only the other of the two stereo channels, and when the background music data is reproduced without reproducing of the audio data, the background music data is reproduced by using both of the two stereo channels.
